(19) United States
(12) Patent Application Publication
(10) Pub. No.: US 2018/0376241 A1
(43) Pub. Date: Dec. 27, 2018

(54) Sound Generator

(71) Applicant: AAC Technologies Pte, Ltd., Singapore city (SG)

(72) Inventors: Bin Zhao, Shenzhen (CN); Sheng Ye, Shenzhen (CN); Ye Shang, Shenzhen (CN); Minmin Chen, Shenzhen (CN)

(21) Appl. No.: 15/819,123

(22) Filed: Nov. 21, 2017

(30) Foreign Application Priority Data
Jun. 22, 2017 (CN) 201720744057.1

(51) Int. Cl. H04R 1/28; H04R 1/02; H04R 31/00

(52) U.S. Cl. CPC H04R 1/2819; H04R 1/025; H04R 31/00; H04R 1/023; H04R 1/288

(57) ABSTRACT

The present disclosure provides a sound generator. The sound generator includes a housing with a cavity; a speaker unit accommodated inside the cavity; and a mesh housing arranged inside the cavity. The mesh housing is compression molded from an acoustic transmission mesh and includes an opening. An inner wall of the housing covers the opening and encloses jointly with the mesh housing for forming an accommodation cavity for encapsulating sound absorbing powder inside.

### FIELD OF THE PRESENT DISCLOSURE

The present disclosure relates to electro-acoustic transducers, more particularly to sound generator like a speaker box for converting electrical signals to audible sounds.

### DESCRIPTION OF RELATED ART

With the rapid development of portable electronic products such as mobile phone, the users have increasingly higher requirements for the functions of products, hence the development of sound generator is also accelerated correspondingly. A sound generator of related art comprises a housing with a cavity and a speaker unit installed on the housing. As the cavity is in a sealed structure with relatively small volume, the resonance frequency of sound generator is high, resulting in inferior low-frequency performance of sound generator, thus hard to send out solid and rich low sound. However, the miniaturization development of sound generator imposes limit to the specifications of sound generator, it's hard to achieve the improvement of low-frequency performance of sound generator simply by expanding cavity. To improve the issue of low-frequency performance, in the sound generator of prior art, sound absorbing material is filled into the cavity and encapsulated by a shell. However, the shell encapsulating the sound absorbing material is generally molded by plastic compression or bracket injection.

Therefore it is necessary to provide an improved sound generator for overcoming the above-mentioned disadvantages.

### BRIEF DESCRIPTION OF THE DRAWINGS

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an illustrative isometric view of a sound generator in accordance with an exemplary embodiment of the present disclosure.

FIG. 2 is cross-sectional view of the sound generator in FIG. 1.

FIG. 3 is an isometric view of a mesh housing of the sound generator in FIG. 1.

### DETAILED DESCRIPTION OF EXEMPLARY EMBODIMENT

The present disclosure will hereinafter be described in detail with reference to an exemplary embodiments. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

All the shells filled with sound absorbing material of prior art are molded by plastic compression or bracket injection, the shell cannot breathe, so that the sound absorbing material in the shell has small or even absolutely no area of contact with the outside, thus the performance of sound absorbing material cannot be brought into full play.

In the present disclosure, to bring the sound absorbing material into full play and further improve the low-frequency performance of products, by using metal mesh or high-strength mesh fabric as raw material and producing the shell through mold compression, a mesh housing for filling in the sound absorbing powder is made, which can breathe all around to remarkably increase the area of communication between the sound absorbing powder and the outside and improve the rate of effective contact between the sound absorbing powder and the air, thus further improving the low-frequency performance of the products.

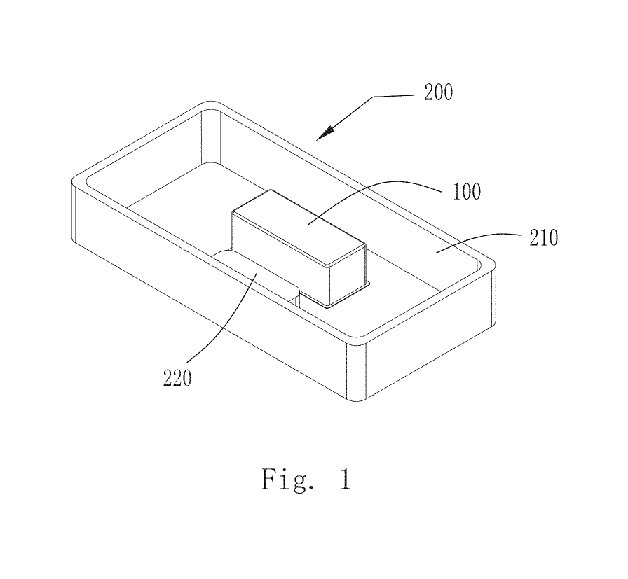

Specifically, referring to FIG. 1, a sound generator 200, in accordance with an exemplary embodiment of the present disclosure, includes a mesh housing 100 for filling in sound absorbing powder. The mesh housing 100 is filled with sound absorbing powder. The mesh housing 100 is connected with a case 210 of the sound generator in such ways as gluing or heat melting, pasting the mesh housing 100 to the inside of the case 210.

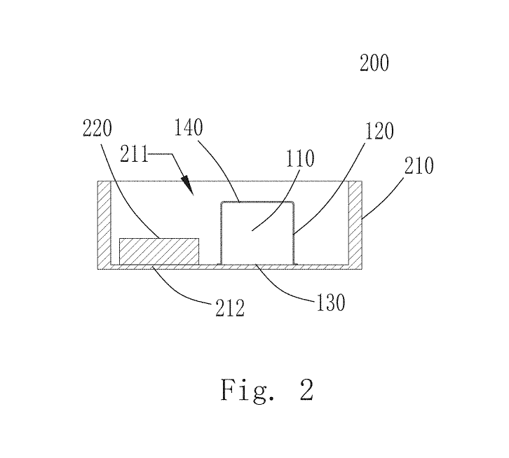

Specifically, as shown in FIG. 2, the sound generator 200 of the present disclosure comprises the case 210 with a cavity 211 and a speaker unit 220 accommodated inside the cavity 211. The sound generator 200 further comprises the mesh housing 100 provided inside the cavity 211. The mesh housing 100 has an opening 130, the mesh housing 100 is compression molded from an acoustic transmission mesh, an inner wall of the case 210 covers to connect the opening 130 and enclose jointly with the mesh housing 100 to form an accommodation cavity 110 with sound absorbing powder encapsulated inside the accommodation cavity 110.

Through mesh holes on the mesh housing 100, the sound absorbing powder inside the mesh housing 100 can have full contact with the outside, thus increasing communication area and improving the low-frequency performance of the sound generator 200.

The acoustic transmission mesh of the present disclosure can be metal mesh or anti-dust mesh. It is easy for compression molding and has stable shape after molding with sufficient strength.

The mesh housing 100 and the speaker unit 220 of the present disclosure are installed in parallel at the inner wall 212 of the housing, ensuring the sound-absorbing performance, and part of sound energy can be transmitted into the mesh housing 100 encapsulated with sound absorbing powder through the inner wall 212 of the housing.

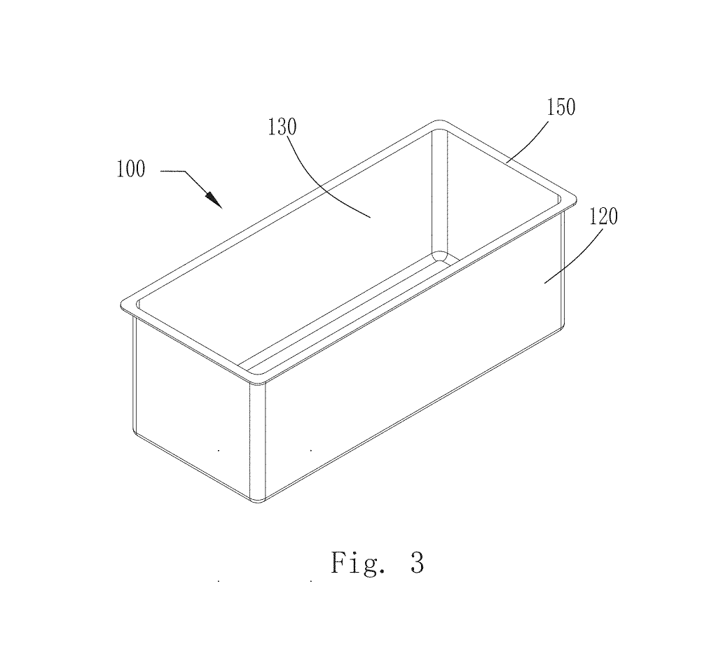

Specifically, as shown in FIG. 2 and FIG. 3, the mesh housing 100 comprises a side wall 120 for forming the accommodation cavity 110 reserved with an opening 130. The opening 130 can be one or more, the mesh housing 100 of the present disclosure seals the opening 130 by use of the case 210, in other embodiments, a sealing cover may be provided separately in cooperation with the side wall 120 to seal the opening 130.

In the present disclosure, to improve the strength of the mesh housing 100, the mesh housing 100 further comprises a base shell 140 connected with one end of the side wall 120 to form the base shell 140 integrally while forming the side wall 120 through compression, so as to ensure the structural stability of the molded mesh housing 100 and also facilitate the installation of the mesh housing 100 inside the sound generator. As shown in FIG. 2, the base housing 140 is planar in shape, the side wall 120 extends from the edge of the base housing in a same direction. The opening 130 is sealed off by the housing inner wall 212. The housing inner wall 212 and the mesh housing 100 enclose the accommodation cavity 110. It shall be noted that, the contour of the side wall 120 can be set according to the space of the sound generator 200 and the sound absorbing performance desired to be set, the side wall 120 can have a contour of square, round or elliptical or other curve shaped, to give the shape of the mesh housing 100 as square, round or elliptical.

To facilitate both the installation of the mesh housing 100 in the sound generator 200 and capture of the mesh housing 100 during handling, as shown in FIG. 3, a fold-over edge 150 is provided at one end of the side wall 11 0, the fold-over edge 150 is used for supporting the mesh housing 100. Meanwhile, the fold-over edge 150 also improves the strength of the mesh housing 100, reduce the deformation during handling or exposure to compact or force. As shown in FIG. 2, the fold-over edge 150 of the mesh housing 100 of the present disclosure is provided at one end of the opening 130, so that the fold-over edge 150 also facilitates to fix the mesh housing 100 onto the case 210 of the sound generator, for example, add bonding or connection area. The fold-over edge 150 of the present disclosure can either fold over and extends outwards or inwards, to facilitate the filling of the sound absorbing powder, the fold-over edge 150 folds over and extends outwards, thus increasing the opening area of the opening 130. As shown in FIG. 2, the fold-over edge 150 is fixed with the housing inner as wall 212. Furthermore, the fold-over edge 150 folds over and extend from the opening 130 towards the outside of the accommodation cavity 110, and affixes with the housing inner wall 212.

Optionally, the fold-over edge 150 and the housing inner wall 212 are adhesively fixed, easy for production and adjustment; in some embodiments, the fold-over edge 150 and the housing inner wall 212 are hot-melt fixed together with the housing inner wall 212, thus facilitating installation and improving production efficiency.

The present disclosure provides a sound generator 200 which comprises a mesh housing 100 filled with sound absorbing powder, a speaker unit 220 and a case 210, the mesh housing 100 and the speaker unit 220 are provided inside the case 210. The sound absorbing powder inside the mesh housing 100 has full contact with the outside, thus increasing communication area and improving low-frequency performance. The mesh housing 100 is connected with the housing inner wall 212 in a way of gluing or heat melting.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A sound generator comprising:
a housing with a cavity;
a speaker unit accommodated inside the cavity;
a mesh housing arranged inside the cavity, the mesh housing being compression molded from an acoustic transmission mesh and including an opening; wherein
an inner wall of the housing covers the opening and encloses jointly with the mesh housing for forming an accommodation cavity for encapsulating sound absorbing powder inside.

2. The sound generator as described in claim 1, wherein the acoustic transmission mesh is a metal mesh or anti-dust mesh.

3. The sound generator as described in claim 2, wherein the mesh housing and the speaker unit are installed in parallel at the inner wall of the housing.

4. The sound generator as described in claim 3, wherein the mesh housing is square, round or elliptical in shape.

5. The sound generator as described in claim 1, wherein the opening of the mesh housing is provided with a fold-over edge fixed together with the inner wall of the housing.

6. The sound generator as described in claim 5, wherein the fold-over edge bends to extend toward outside of the accommodation cavity and fits with the inner wall of the housing.

7. The sound generator as described in claim 5, wherein the fold-over edge is adhesively fixed together with the inner wall of the housing.

8. The sound generator as described in claim 5, wherein the fold-over edge is hot-melt fixed together with the inner wall of the housing.
